(19) United States
(12) Patent Application Publication
(10) Pub. No.: US 2015/0333597 A1
(43) Pub. Date: Nov. 19, 2015

(54) VALVE PROVIDED WITH A MULTIPHASE LINEAR ACTUATOR FOR HIGH PRESSURE DOSING

(71) Applicants: Stéphane CREMER, Seloncourt (FR); antoine FOUCAT, Montarlot les Rioz (FR); Simon GYGER, Tramelan (CH); Chirstophe HABEGGER, Reconvilier (CH); Sonceboz SA, Sonceboz (CH)

(72) Inventors: Stéphane CREMER, Seloncourt (FR); Antoine FOUCAUT, Montarlot Les Rioz (FR); Simon GYGER, Tramelan (CH); Christophe HABEGGER, Reconvilier (CH)

(73) Assignee: SONCEBOZ SA, Sonceboz (CH)

(21) Appl. No.: 14/435,832

(22) PCT Filed: Aug. 28, 2013
(86) PCT No.: PCT/FR2013/051986

§ 371 Date: Apr. 15, 2015

(30) Foreign Application Priority Data
Oct. 16, 2012 (FR) 12 59848

(51) Int. Cl. H02K 7/06; F16K 31/04; H02K 29/08; F16K 3/30

(52) U.S. Cl. CPC H02K 7/06; F16K 3/30; F16K 31/046; H02K 29/08

(57) ABSTRACT

The present disclosure concerns a fluid dosing valve displaced by an electric actuator generating the translation of a shutter, the electric actuator including a multiphase motor including a stator having a plurality of wound poles formed by stacking a plurality of sheets and a rotor including a transmission transforming rotational movement into the linear movement of an output member, a non-magnetic sleeve insulating the rotor from the stator, and magneto-sensitive elements for detecting the position of the rotor. These magneto-sensitive elements are placed on the outside of the sleeve and sense the position of the rotor through the insulating sleeve.

### CROSS-REFERENCE TO RELATED APPLICATIONS

This application is a National Phase Entry of International Application No. PCT/FR2013/051986, filed on Aug. 28, 2013, which claims priority French Patent Application Serial No. 1259848, filed on Oct. 16, 2012, both of which are incorporated by reference herein.

### TECHNICAL FIELD

The invention relates to a valve comprising a linear actuator consisting of a multiphase electric motor formed by a stator and a rotor, with the latter acting as a control member through driving means so designed as to be capable of transforming the rotational movement of the rotor into a linear movement of the control member. The present invention finds a particular application in the cases where a dosing function is desired and provided by a linear displacement of a shutter regulating a flow of fluid under high pressure in a valve requiring a complete sealing. Many solutions are currently available for the electric actuator provided on the high pressure dosing valves.

### BACKGROUND

Two types of solutions known in the prior art can be mentioned:

The first family consists of a system with a dynamic sealing. In this case, the electric actuator induces the translation of a control member integral with the shutter, which cooperates with an elastic element which must ensure the tightness of the system. This type of solutions make it possible to keep electric actuators of a traditional construction but have two major drawbacks, i.e.: A high friction is caused by the elastic element which must exert a significant pressure onto the moving parts for ensuring the dynamic sealing. Such friction reduces the force available for controlling the shutter and is responsible for the large size of the motors and thus for relatively high component costs. A lack of reliability appears over time because friction eventually wears the gasket which can no longer guarantee a perfect sealing of the control member over a long service life, especially when pressure inside the valve is very high, i.e. ranges from 30 to 100 bars.

The second family of valves known in the prior art for a linear dosing function under a high pressure consists of static sealing systems, i.e. sealing is provided by not moving components such as elastomer seals, which are compressed between two stationary components. These solutions are based on the use of a sleeve having a small thickness, which is placed between the stator part and the rotor part of the electric motor, and makes it possible to confine the moving parts of the rotor in a closed and sealed space, with such sleeve being made of a non-magnetic material so as not to disturb the magnetic circuit of said electric motor.

These solutions have a significant advantage which consists in totally immersing the rotor part in the environment under pressure, so as to avoid providing a dynamic sealing and thus overcome the aforementioned drawbacks. The sleeve, which enables to close the pressure chamber, is sealingly connected to the valve body by means of a polymer seal or a tight welding, with such two elements being stationary. The electric motor of the prior art consists of a stator part made of sheets having a low thickness, which fits over the sealing sleeve thus enclosing the rotor therein.

In the solutions of the prior art, the electric motors use the so-called “Tin Can” technology. Such motors have a stator consisting of two thin metal sheets wound on coaxial coils parallel to the axis of rotation of the rotor. Such motor configuration has a magnetic gap, i.e. a small distance between the rotor magnet and the stator teeth. If this gap increases, the performances of such “Tin Can” motors are affected. The linear actuators solutions having a dosing function, based on such motors, are thus interesting only when the thickness of the sealing sleeve is low and makes it possible to keep a magnetic gap with the same order of magnitude as the thickness of the stator teeth. When the thickness of the sleeve and thus the air gap increase, magnetic short circuits are generated which bring the motor performances down and reduce the efficiency of the dosing system.

This second family of actuators for dosing systems, currently described in the prior art by the combination of step-by-step motors of the “Tin Can” type with a rotor chamber is interesting for controlling valves working under low or medium pressures. However, it cannot be used for high pressures, when the sleeve thickness must be greater due to the material strength, with such increase being incompatible with the magnetic circuit of these motors.

In addition, another technology of multiphase electric motor exists, including means for transforming the rotational movement into a linear movement, and making it possible to work with higher magnetic gaps. Such motors have coils positioned radially on the stator, which has teeth formed by a stack of many sheets which result in a large section of iron.

It should be noted, for example, that the solutions described in the patents FR2837032 and FR2754953, which describe several solutions for transforming a movement inside the motor rotor, but also a motor structure having a large section of the stator teeth. The magnetic structure of such motors even makes it possible to more easily accept an increase in the magnetic gap and interesting performances are thus preserved when the space between the outer diameter of the magnet and the inner diameter of stator increases. A thicker sleeve capable of withstanding pressures in the range of 50 to 100 bars can thus be inserted into this more comfortable gap.

The patent GB907521 is also known, which discloses a solenoid valve providing the measurement of the position of the valve head and more precisely of the linear extension of the valve head, and not the angular position of the rotor. This patent describes a solution with a magnetic ring bearing reference number 36, placed opposite a graduation bearing reference number 35. This solution does not make it possible, in any way, to solve the problem of the invention regarding the precise control of the multiphase motor from electronics receiving information on the angular position of the rotor. It just enables rough information on the level of linear extension of the valve head to be provided.

The European Patent EP1126582 does not relate to a valve but to a linear actuator. Sealing is thus not a problem, and moreover is not addressed by this patent of the prior art. This document describes the use of a Hall probe 14 for providing information on the angular position of the rotor to motor control electronics.

The presence of a cup-shaped wall 31 between the stationary parts and the moving parts to prevent the passage of debris from the moving parts to the other parts is mentioned. The problem aimed at by the invention is not addressed at all: no attempt is made to provide the sealing required for a valve intended for dosing fluid, sometimes under high pressures. In particular, the ball bearing with reference number 9 does not provide any sealing to the rotor surrounded by the wall bearing reference number 31.

### SUMMARY

The present invention aims at overcoming the limitations of the prior art solutions described above and provides for a linear actuator comprising a multiphase electric motor, consisting of a stator having a plurality of wound poles formed by stacking a plurality of sheets, and a rotor comprising means for transforming the rotational movement into a linear movement, a non-magnetic sleeve insulating the rotor from the stator, and finally magneto-sensitive elements for detecting the position of the rotor, characterized in that the magneto-sensitive elements are placed outside the sleeve and are adapted to detect the magnetic flux density of the rotor through the insulating sleeve.

According to a first embodiment, the linear actuator includes a stator part comprising a housing surrounding the wound stator. The housing includes a recess for an electronic card for connection with the coil pins, and such electronic system comprises magneto-sensitive elements with a low thickness which enable an automatic welding identical to the other board components so as to optimize the production costs. Such so-called “SMD—Surface Mounting Design” flat components enable a detection of the magnetic field in a direction parallel to the rotor axis, so they are positioned on a radius close to that of the magnet. The shape of the sleeve includes a shoulder on the front part, which makes it possible to hold it between the motor housing and the valve body housing in order to take up the axial stress resulting from the fluid pressure which applies onto the bottom of the sleeve. The bottom of the sleeve has a rounded shape with a progressive thickness in order to ensure a homogeneous distribution of stress, to optimize the weight and to reduce the risk of cracks.

The rotor has a radially magnetized cylindrical magnet, the length of which is substantially greater than the height of the stator made of interlocked sheets. Such protrusion makes it possible to use the rear part of the motor magnet for exciting the magneto-sensitive elements, through the sleeve. The magnetic flux generated by the rear part of the motor magnet is used to position the magneto-sensitive elements on a radius greater than that of the outer diameter of the motor magnet.

The sleeve forms an enclosure totally and sealingly insulating the stator, and more particularly the windings thereof, the position sensor and the electric connections on the one hand, and the rotor and the mechanical connection with the valve head on the other hand. This prevents the fluid, specifically the pressurized fluid, to flow into the parts of the actuator connected to the electric current. Any defective sealing at the connection between the actuator and the valve head will only result in the fluid flowing into the body of the sleeve containing the rotor, which is inert and less sensitive than the electrically powered stator.

The nut secured to the rotor is helically associated with the screw, which constitutes the control element and which is integral with the valve shutter, which is guided by a sliding connection in the dosing device body. The anti-rotational function required for transforming the movement is provided outside the electric actuator, inside the valve, in order to optimize the overall height of the dosing system. The construction of the electric actuator then requires the displacement travel only once at the screw/nut connection, whereas such actuators usually require, in addition to such helical travel, a second travel following a straight profile to achieve the anti rotation required for transforming the rotation of the rotor into the translation of the screw.

The rotor is guided by rolling elements, which have inherent axial clearance. To take up such clearance, an elastic system is inserted between the front sleeve of the rotor and the front bearing. Such elastic element exerts a force onto the front bearing, the rotor and the rear bearing, the value of which is chosen to be greater than the maximum value of the stress expected from the actuator control member on the valve shutter. The nut is thus subjected to the force of the elastic member on the one hand, and on the other hand to the force of the screw, the direction of which depends on the direction of displacement. As such sum is positive whatever the direction of the movement of the shutter, the rotor does not translate into the sleeve and the axial accuracy of the system is optimized.

The elastic element also makes it possible to force the ball thrust bearing positioned at the bottom of the sleeve, so that it provides the centring of the rotor in addition to the ball bearing positioned at the front of the rotor. As a matter of fact, this ball bearing can provide a cylindrical guiding only if it is axially loaded to enable the self-centring of the sleeves by the bearing balls. This type of bearing is interesting for its low height and makes it possible to reduce the length of the insulating sleeve with respect to the length of the magnet.

The drive train between the rotor nut and the shutter has rotational and translational clearance resulting from the various connections in cascade. When the accuracy of the shutter positioning is high, it may be necessary to find a solution for compensating the axial clearance. Such compensation may be provided either mechanically or electronically. According to a first embodiment, the compensation is electronic and the motor control system incorporates a function capable of compensating such clearance by correcting the position command by adding thereto the value of the mechanical clearance of the drive train.

According to a second embodiment, the magneto-sensitive elements have long legs which go through the plane of the circuit and are assembled according to a method using heated wedge welding. Such magneto-sensitive elements are offset from the plane of the electronic circuit so as to engage the teeth of the stator part, while still being located outside the high pressure chamber defined by the insulating sleeve. In this embodiment, the magneto-sensitive elements detect the radial component of the rotor induction.

The insulating sleeve is in the form of a cylinder extended by a straight stepped bottom having a constant wall thickness, defined according to the maximum fluid pressure and the ultimate strength of the sleeve material. The shoulder at the bottom of the sleeve first makes it possible to position the magneto-sensitive elements closer to the end of the magnet so as to improve the quality of the position signal, but also to reduce the internal recess in the electronic board carrying the components required for the motor control. This second embodiment, rather advantageous under lower pressures, provides a greater useful surface for the electronic card.

### BRIEF DESCRIPTION OF THE FIGURES

Other characteristics and advantages of the invention will become apparent upon reading the following detailed description of exemplary embodiments with reference to the appended figures, wherein:

FIGS. 1a and 1b show a sectional view of a device according to a first embodiment of the invention; and

FIG. 2 shows a sectional view of a device according to a second embodiment.

### DETAILED DESCRIPTION

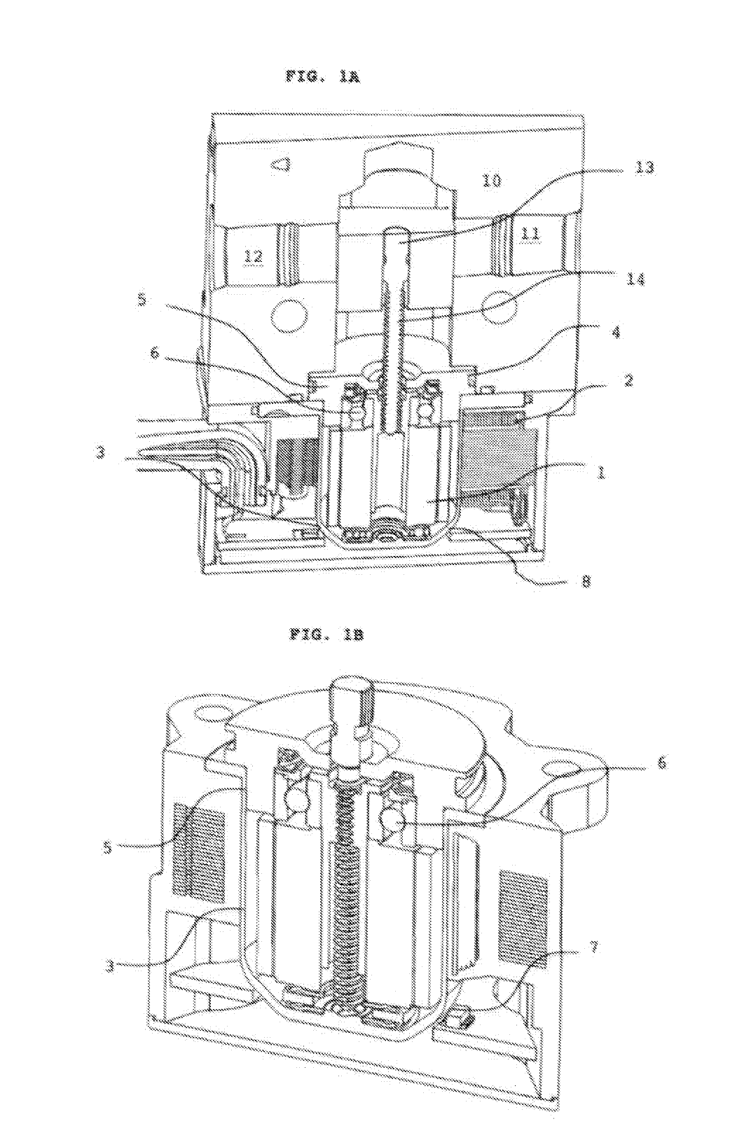

The device shown in FIGS. 1a and 1b is particularly adapted to the control of high pressure valves. The valve described by way of a non limiting example comprises, in a known manner, a head 10 having a through bore forming an inlet duct 11 and an outlet duct 12. A shutter 13, driven by a threaded screw 14, moves inside the bore between a closed position, where the shutter 13 completely blocks the fluid flow between the inlet duct 11 and the outlet duct 12, and an open position, where the shutter 13 is removed from the fluid flow.

The threaded screw 14 is driven by a step-by-step motor, comprising a stator 2 and a rotor 1 and sealing means preventing the fluid from penetrating into the stator part 2 and the electric control elements. The stator 2 and rotor 1 assemblies are separated by a non-magnetic metal sleeve 3 closed by a plug 5 which the threaded screw 14 goes through, the thickness of which varies so as to homogenize the internal mechanical stress. Such non-magnetic sleeve 3 forms a casing surrounding the rotor 1. The cylindrical wall of such non-magnetic sleeve 3 fits in the air gap between the peripheral surfaces of the stator 2 and the rotor 1 and does not affect the circulation of magnetic flux.

The sleeve 3, together with a plug 5, forms a closed enclosure having a single opening for the passage of the threaded screw 14 which controls the valve head. The plug 5—or the sleeve 3—provides the centring of the rotor by means of a ball bearing 6. The cylindrical wall of the sleeve 3 is closed by a substantially hemispherical bottom 8, the central area of which is provided with a system for guiding the end of the threaded screw 1′.

The assembly consisting of the sleeve 3 and the plug 5 is accommodated in the housing containing the rotor assembly, specifically the coils, the electric connections and the sensor 7. The connection between this assembly and the housing is totally sealed.

The non-magnetic sleeve 3 thus totally insulates:
the volume defined by the space inside the sleeve 3 and the plug 5 thereof, which contains the rotor 1 and communicates with the valve head 10 and specifically the threaded screw 14 and the shutter

the volume defined by the housing comprising the stator 2 and the electric connections and circuits, and the sensor 7.

A static seal 4 provides a sealed casing around the movable components, so that the seals are used between the valve body and the assembly consisting of the sleeve 3 and the plug 5 only. The plug 5 carries the rotor guiding bearing 6 and is inserted into the sleeve 3. The connection is provided by a force fitting or, where sealing is required between these parts, by welding. The anti-rotational function required to operate the screw/nut system is not provided in the actuator, but through the guiding of the shutter of the valve 13 wherein the screw is embedded.

The rotor 1 is thus accommodated in the sleeve 3 forming, with its plug 5, a sealed casing preventing the fluid from flowing to the stator 2, but letting the magnetic field through thanks to the non-magnetic nature of the material used for such sleeve. Driving is provided by a multiphase stator associated with control electronics, taking into account a rotor 1 actual position signal. Such circuit makes it possible to compensate for any clearance and discrepancy between the theoretical position and the actual position of the shutter.

The cumulated clearance in the drive train between the rotor 1, the screw 14 and the shutter 13 result in the shutter 13 being incorrectly positioned. The magneto-sensitive elements 7 capable of detecting the actual position of the rotor enable the motor control system to take account of such mechanical hysteresis and to take up such clearance upon reverting the direction of rotation.

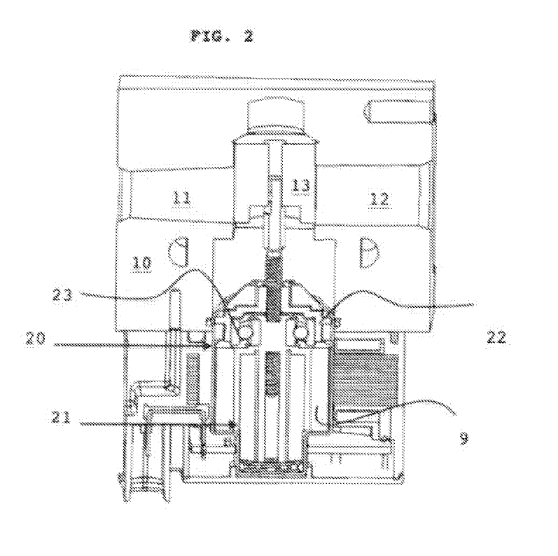

FIG. 2 shows a sectional view of the solution according to a second embodiment, wherein the sleeve 3 has a constant wall thickness and a straight shoulder 9, so as to reduce the electronic circuit through hole and to enable a better positioning of the magneto-sensitive elements opposite the rotor magnet. The sleeve 3 thus has a main cylindrical part 20 surrounding the rotor magnet, and a cylindrical part 21 with a lower section, connected together by the shoulder 9.

The plug 22 carrying the ball bearing 23 closes the main part 20 of the sleeve 3. Crimping makes it possible to hold such sleeve 22 while providing an axial preload required for operating the rear ball thrust bearing which centres the rotor. Static sealing is provided by means of one or more traditional O-ring(s) placed between the outer diameter of the sleeve and the bore of the valve body. Such seals ensure a maximum sealing since they are not submitted to any friction upon the opening and closing controls of the valve.

1. A fluid dosing valve operated by an electric actuator generating the translation of a shutter, with the electric actuator comprising a multiphase motor comprising a stator having a plurality of wound poles formed by stacking a plurality of sheets, and a rotor comprising a transmission transforming rotational movement into a linear movement of an output member, with a non-magnetic sleeve insulating the rotor from the stator, and magneto-sensitive elements detecting a position of the rotor, and the magneto-sensitive elements being outside the sleeve and sensing the position of the rotor through the insulating sleeve , with the non-magnetic sleeve being configured as to completely insulate:
(a) a volume defined by a space inside the assembly formed by the sleeve and the plug, and containing the rotor and communicating with the valve head, the threaded screw and the shutter; and
(b) a volume defined by a space outside the assembly formed by the sleeve and the plug, and comprising the stator, the electric circuits and connections.

2. A fluid dosing valve according to claim 1, wherein the linear movement of the shutter is obtained by adding a helical connection acting between the rotor and the screw located inside the electric actuator with a second slidable connection acting between the shutter and the valve body, located outside the actuator.

3. A fluid dosing valve according to claim 1, wherein the mounting of the insulating sleeve in the body of the valve imparts a constraint onto a static seal capable of working under a high pressure.

4. A fluid dosing valve according to claim 1, wherein the insulating sleeve has a stepped bottom creating a housing for the magneto-sensitive elements on a diameter close to that of the rotor magnet.

5. A fluid dosing valve according to claim 1, wherein the insulating sleeve has a shape suitable for receiving a rotor guiding element.

6. A fluid dosing valve according to claim 1, wherein the insulating sleeve has a fastening flange which transmits the axial stress caused by pressure to the valve body.

7. A fluid dosing valve according to claim 1, wherein the insulating sleeve has a high quality surface capable of cooperating with a static seal arranged between the sleeve and the valve body.

8. A fluid dosing valve according to claim 1, wherein the rotor guiding comprises at least one axial ball thrust bearing cooperating with an elastic axial loading element.

9. A fluid dosing valve according to claim 1, wherein the insulating sleeve comprises a crimping which imparts an axial constraint to the rotor rotation guide elements to cancel any clearance.
